(19) United States
(12) Patent Application Publication
(10) Pub. No.: US 2026/0141585 A1
(43) Pub. Date: May 21, 2026

(54) SYSTEMS AND METHODS FOR INDOOR MAPPING

(71) Applicant: MappedIn Inc., Waterloo (CA)

(72) Inventors: James Nathan Swidersky, Kitchener (CA); Erkang Wei, Waterloo (CA)

(21) Appl. No.: 19/389,760

(22) Filed: Nov. 14, 2025

Related U.S. Application Data
(60) Provisional application No. 63/721,015, filed on Nov. 15, 2024.

(51) Int. Cl. G06T 11/20; G01S 17/42; G01S 17/89; G06T 17/00; G06V 10/762; G06V 10/764; G06V 10/774; G06V 10/82

(52) U.S. Cl. CPC G06T 11/23; G01S 17/42; G01S 17/89; G06T 17/00; G06V 10/762; G06V 10/764; G06V 10/774; G06V 10/82; G06T 2210/04; G06T 2210/56

(57) ABSTRACT

Provided are systems and methods for creating indoor maps from building point cloud data. A method for indoor mapping includes identifying levels in the building point cloud data, by identifying clusters of high ceiling/floor point density, preceding ceiling/floor minimas and following ceiling/floor minimas flanking the clusters of high ceiling/floor point density and identifying walls in the building point cloud data at the level, by identifying clusters of high wall point density, preceding wall minimas and following wall minimas flanking the clusters of high wall point density.

### TECHNICAL FIELD

The embodiments disclosed herein relate to indoor mapping, and, in particular to systems and methods using point cloud data to generate indoor maps.

### INTRODUCTION

Indoor maps of a building can be created in several ways. One approach is to use an existing architectural design file (e.g., a CAD file) as the basis for creating an indoor map, for example, as disclosed in U.S. Patent Publication No. 20210303763, to the same applicant, the entirety of which is incorporated herein by reference.

Another approach is to scan the interior of a building to generate 3D point cloud data which can be used to model the building interior (walls, floors, ceilings) to create a 3D model or a floor plan of the building, for example, as disclosed in U.S. Pat. Nos. 11,282,270, 9,811,714, 10,832,079 and 10,387,582.

Beyond generating a simple 3D model or floor plan of a building, it is desirable to create a map of a building including architectural features that are present in the building interior such as doors, windows, stairs, furniture, etc. It is also desirable to provide a system that can automatically process building point cloud data to generate an indoor map with minimal user input.

Accordingly, there is a need for new and improved systems and methods for creating indoor maps from building point cloud data.

### SUMMARY

According to some embodiments, there is a computer-implemented method for indoor mapping. The method includes classifying building point cloud data as wall points or ceiling/floor points according to normals of the points in the building point cloud data and identifying levels in the building point cloud data, by a machine learning algorithm, configured to identify clusters of high ceiling/floor point density, preceding ceiling/floor minimas and following ceiling/floor minimas flanking the clusters of high ceiling/floor point density.

For each level identified, the method further comprises identifying walls in the building point cloud data at the level, by a machine learning algorithm configured to identify clusters of high wall point density, preceding wall minimas and following wall minimas flanking the clusters of high wall point density; fragmenting the ceiling/floor points and the wall points, respectively; performing plane detection on the ceiling/floor points and the wall points, respectively; merging detected floor planes to get a basic floor geometry; merging detected wall planes to get a basic wall geometry.

Walls points in the wall planes are flattened to a 2D representation and wall points are grouped based on wall point cloud density to segment wall regions. Clusters of low wall point density are then classified as architectural features by a trained neural network, the architectural features including at least doors, windows and stairs.

Line intersections between wall planes and ceiling/floor planes are found to define 3D walls. A 2D floor map is then generated passed on the basic floor geometry and including the architectural features. A 3D representation of the floor may also be generated from the 3D walls and including the architectural features.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a diagram of a system for indoor mapping, according to an embodiment;

FIG. 2 is flow chart of a method for indoor mapping, according to an embodiment; and

FIG. 3 is exemplary 3D building point cloud data;

FIG. 4A shows the building point cloud data of FIG. 3 after down sampling, according to an embodiment;

FIG. 4B shows the building point cloud data of FIG. 3 after outlier points removed, according to an embodiment;

FIG. 5 shows classification of wall vs. floor/ceiling points according to point normal and elevation, according to an embodiment;

FIG. 6 is a plot of elevation vs. point density for floor/ceiling points, according to an embodiment;

FIG. 7 is a visualization of level segmentation based on clusters of peaks, preceding minimas and following minimas in FIG. 6;

FIG. 8 shows elevation ranges defined for the segmented levels in FIG. 7;

FIG. 9 shows fragmentation of building point cloud data, according to an embodiment;

FIGS. 10A-B show the result of floor planes and wall planes, respectively, detected in the fragments shown in FIG. 9;

FIG. 11 is a basic floor geometry after merging the floor planes in FIG. 10A;

FIG. 12 is a floor shape of the merged floor planes in FIG. 11;

FIG. 13 is a basic wall geometry after merging the wall planes in FIG. 10B;

FIG. 14 is a 2D representation of flattened wall planes as linestrings, according to an embodiment;

FIG. 15 is the 2D representation of FIG. 14 with colored/shaded wall points indicating clusters of low wall point density; and

FIG. 16 is a representation of line detection to find intersections of merged wall planes and merged floor/ceiling planes to define 3D walls, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

As used herein, a “processing unit” refers to a component or system that is designed to execute instructions/algorithms, process data, perform computations, and/or control other components within a system as the case may be. Further, the processing unit may include specific hardware (e.g., a computer processor) and/or software components for performing the above-mentioned tasks. The processing unit may be integrated with other components of a system, such as memory, I/O interfaces, or network interfaces. A processing unit may also include, for example, field programmable gate arrays (FPGAs) or application specific integrated circuits (ASICs) to rapidly perform processing operations.

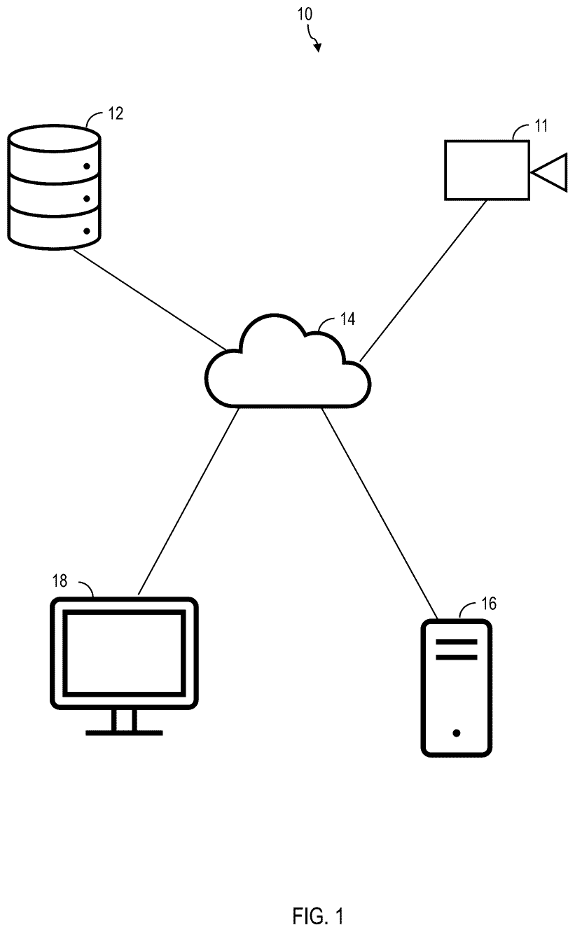

Referring to FIG. 1, shown therein is a diagram of a system 10 for indoor mapping, according to an embodiment.

The system 10 includes a scanning device 11 configured to scan an interior of a building and generate 3D point cloud data representing the interior of the building. The scanning device 11 may be a camera, a LIDAR scanner, or the like. The scanning device 11 may be positioned at various locations or spaces within the building (e.g., rooms, hallways, stairs) to scan the interior of the building and generate and the point cloud data. The scanning device 11 may be configured to stitch together point cloud data of individual spaces within the building to generate overall building point cloud data representing the entire interior of the building. The scanning device 11 may be configured to output the building point cloud data in a point cloud data file format (e.g., a PCD file, a BIN file, etc.)

The system 10 includes a database 12 for storing the building point cloud data. The database 12 may comprise a plurality of storage devices and/or a server. The scanning device 11 may be configured to transmit the captured point cloud data to the database 12 over a wired or wireless communications network 14 (e.g., the internet). According to some embodiments, the scanning device 11 stores the point cloud data locally and the data is transferred to the database 12 on removable storage media.

The system 10 includes a processing device 16. The processing device 16 may be a cloud server or multiple servers operably connected in a distributed computing environment. The processing device 16 is configured to receive the building point cloud data from the database 12 and process the point cloud data to generate 2D and/or 3D maps of the building interior as described herein. The processing device 16 may be configured to execute machine learning algorithms and/or artificial neural networks trained to process the building point cloud data as described herein. The processing device 16 may be further configured to execute or host one or more programs or applications for creating, viewing and editing 2D and/or 3D indoor maps generated from the building point cloud data.

The system 10 includes a display device 18 e.g., a laptop computer, a desktop computer 18, tablet device, or the like. The display device 18 is configured to access the processing device 16 over the communications network 14 or by a direct connection to execute the one or more applications for creating, viewing and editing 2D and/or 3D indoor maps generated from the building point cloud data.

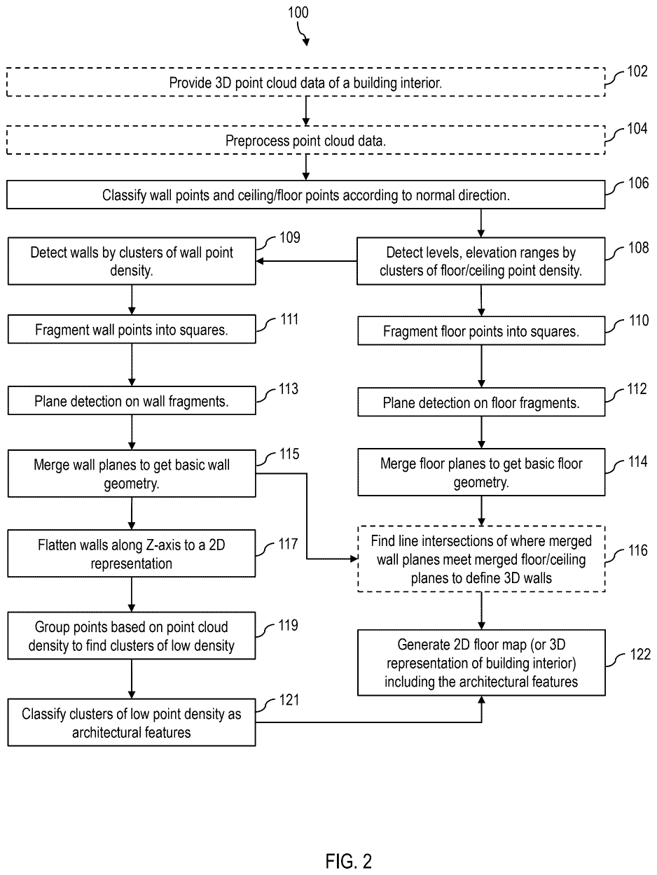

Referring to FIG. 2, shown therein is a flow chart of a method 100 for indoor mapping, according to an embodiment. The method 100 may be performed by the system 10 in FIG. 1.

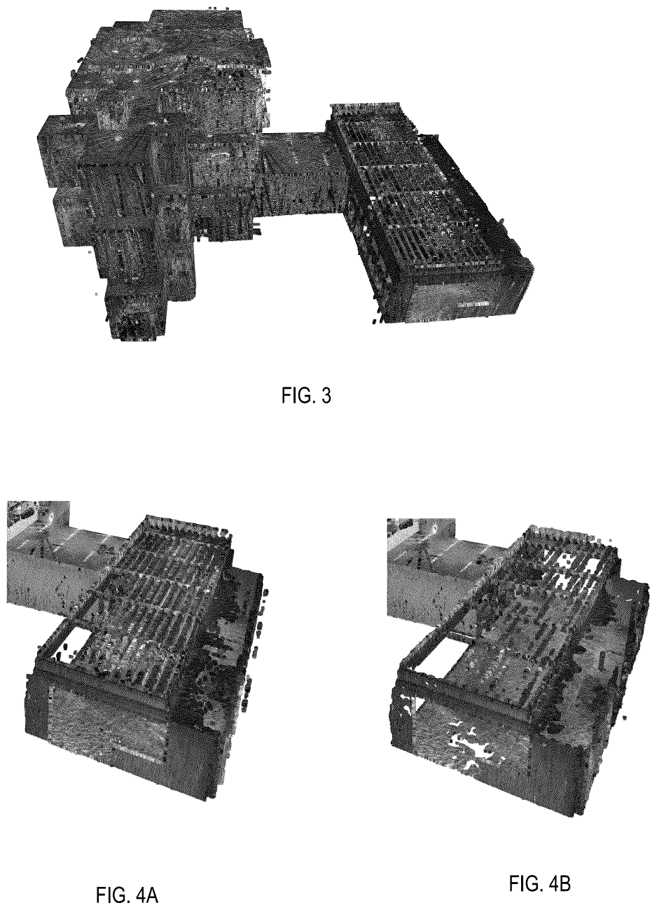

At 102, 3D point cloud data of a building interior is provided. The building point cloud data may be generated by a scanning device (e.g., a LIDAR scanner) positioned at various locations within the building. FIG. 3 shows exemplary 3D point cloud data of a building interior captured by a scanning device.

At 104, the building point cloud data may be preprocessed to generally reduce the number of data points for faster processing. Preprocessing may include, for example, down sampling (FIG. 4A) and/or outlier removal (FIG. 4B). Outlier removal involves eliminating points that are further away from neighbors compared to an average point distance from neighbors in the cloud.

At 106, normals for all points in the building point cloud data are identified and the points are classified as wall points or floor/ceiling points according to the direction of the normal vector. Normals pointing substantially horizontally are classified as wall points. Normals pointing substantially vertically (up or down) are classified as floor/ceiling points. Floor/ceiling points may be further classified by elevation. The classification and subclassification of wall points vs. floor/ceiling points may be performed by a trained machine learning algorithm.

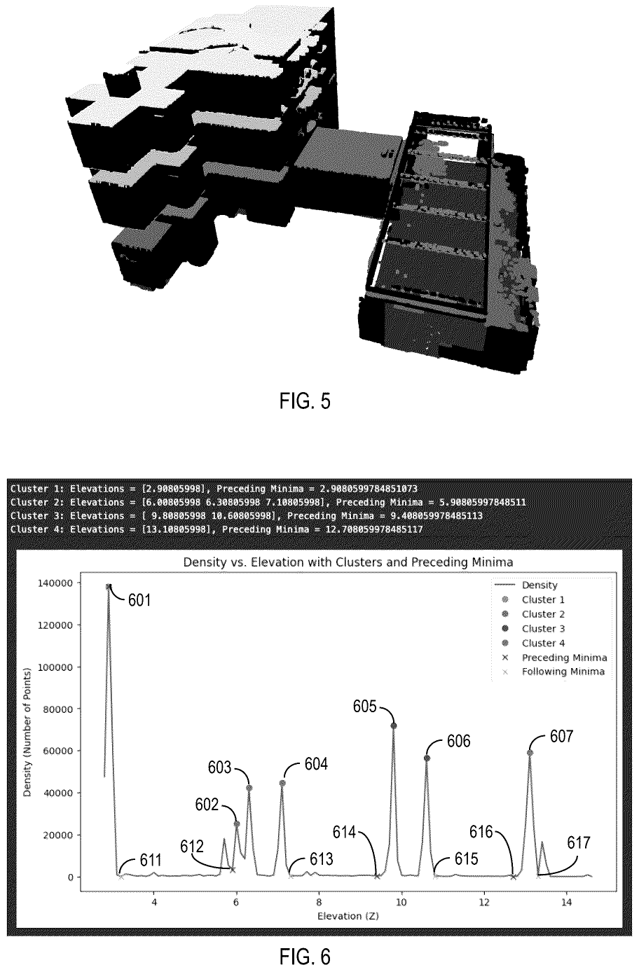

Referring to FIG. 5, shown therein is a classification of wall vs. floor/ceiling points. Wall points are shown in black and floor/ceiling points are shown in different shades of grey according to elevation.

At 108, building levels are identified. This is accomplished by plotting floor/ceiling point density by elevation (i.e., height or position on z-axis). Visually, this can be represented as a plot of elevation vs. point density as shown in FIG. 6. Preferably, this step is performed by a machine learning algorithm trained to identify clusters of peaks as described below.

Referring to FIG. 6, clusters of peaks (regions of high ceiling/floor point density) 601, 602, 603, 604, 605, 606, 607 in the ceiling/floor points are identified. A first cluster includes peak 601; a second cluster includes peaks 602, 603, 604; a third cluster includes peaks 605, 606; a fourth cluster includes peak 607. Clusters of peaks represent the division between levels, that is, a cluster of peaks will contain the ceiling of a first level and the floor of the level immediately above the first level.

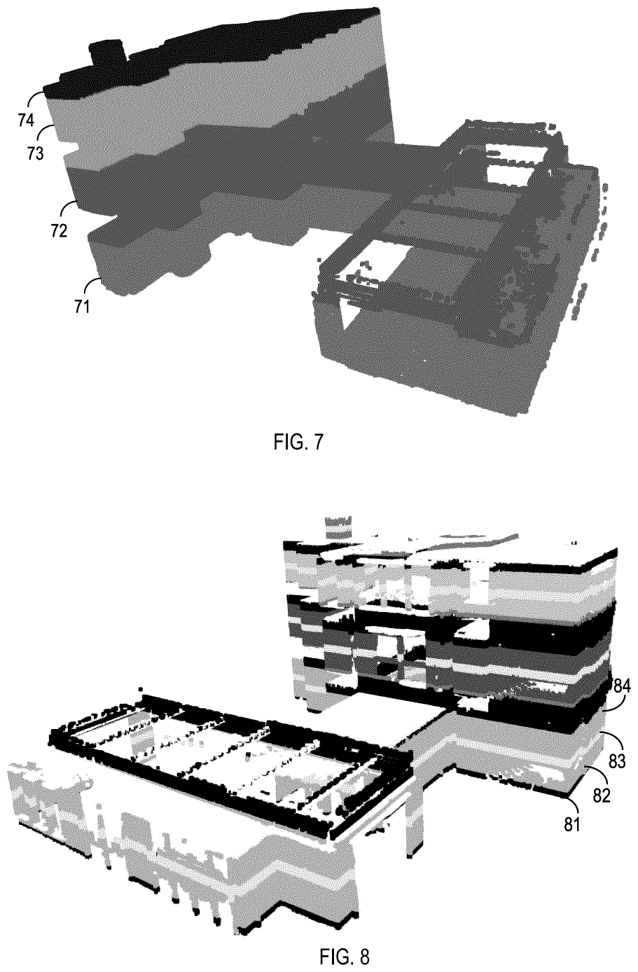

Then, minimas 611, 612, 613, 614, 615, 616, 617 that flank (precede and follow) the clusters of peaks are identified. Preceding minimas 612, 614, 616 signify the points at an elevation of just below the ceiling for a level. Following minimas 611, 613, 615, 617 signify the points at an elevation of just above the floor for a level. Levels of the building are then segmented based on the clusters of peaks, the preceding minimas and the following minimas as shown in FIG. 7 where each color/shade represents a different detected level 71, 72, 73, 74. Identifying levels in this manner may be particularly advantageous in buildings where the floors are not spaced at equal intervals, or where there is inaccessible space (e.g., a utility space) between floors that is not to be included in a map of the building.

At 108, elevation ranges (sublevels) within each level can also be determined as shown in FIG. 8 where each color/shade represents a different detected elevation range. Preferably, sublevels are determined by a machine learning algorithm trained to identify sublevels based on elevation of points. The elevation ranges may correspond to, but are not limited to, a level's floor point layer 81, a level's lower wall section point layer 82, a level's middle wall section point layer 83, a level's upper wall section point layer 84.

In various embodiments, the boundary between sublevels/layers 81, 82, 83, 84 may correspond to real world height/elevation values and may further be adjustable for each level. For example, a level's lower wall section may be defined as points with elevation below a typical eye level of an average person/observer standing on the floor of the level; the middle wall section may be defined as points in elevation extending from the typical eye level up the height of the average person/observer; the upper wall section may be defined points with elevation higher than the middle section up to the level's ceiling. This is advantageous given that observations on differences in point densities for a given wall section/sublevel (e.g., a level's lower wall point layer) can provide insights into classifying characteristics/architectural features of the wall section.

A ML algorithm or neural network may be trained to classify various architectural features based on point density and which sections of a wall the feature is likely to extend over. For example, a high point density for a wall's lower and middle sections, and a low point density in the upper wall section could indicate a half wall, or a window in the upper wall region. In another example, a low point density stretching across a wall's lower, middle and upper sections may indicate a floor-to-ceiling window. Similarly, doors are likely to extend from the floor point layer to at least the middle wall section.

Step 109 performs is essentially the same as step 108, but for points identified as wall points. As in step 108, step 109 involves identifying clusters of peaks representing walls. Preferably this step is performed by a machine learning algorithm trained to identify clusters of wall peaks. Visually, this can be represented as a plot of X/Y position vs. point density similar to FIG. 6 with x/y position along the horizontal axis.

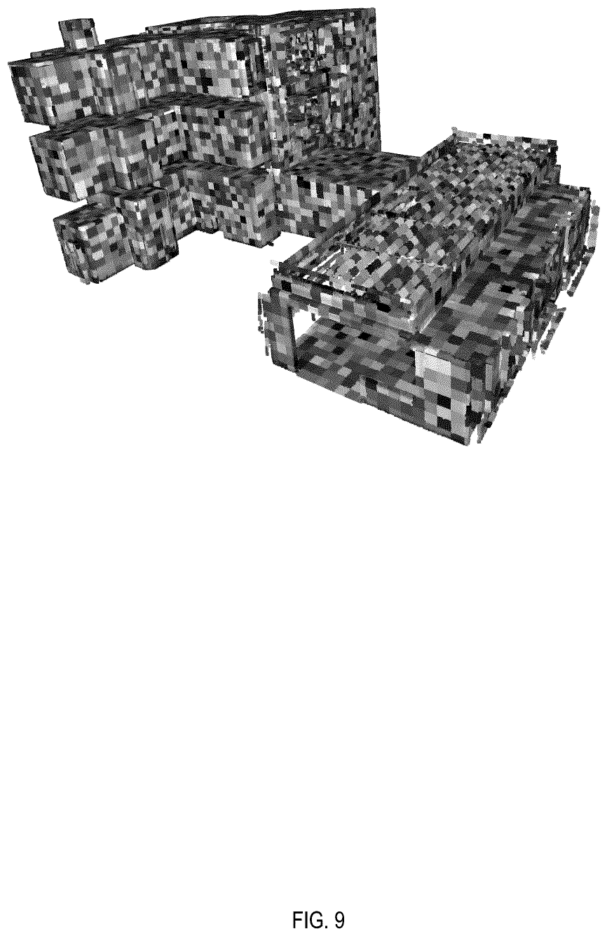

At 110 floor points are spatially fragmented as shown in FIG. 9. In FIG. 9, each different shaded square indicates a fragment of the building point cloud data. Data may be fragmented using, for example, an Octree data structure to segment the data. The size of the fragments can be adjusted depending on complexity and size of the building point cloud data, as well as the amount of detail that is needed for plane detection.

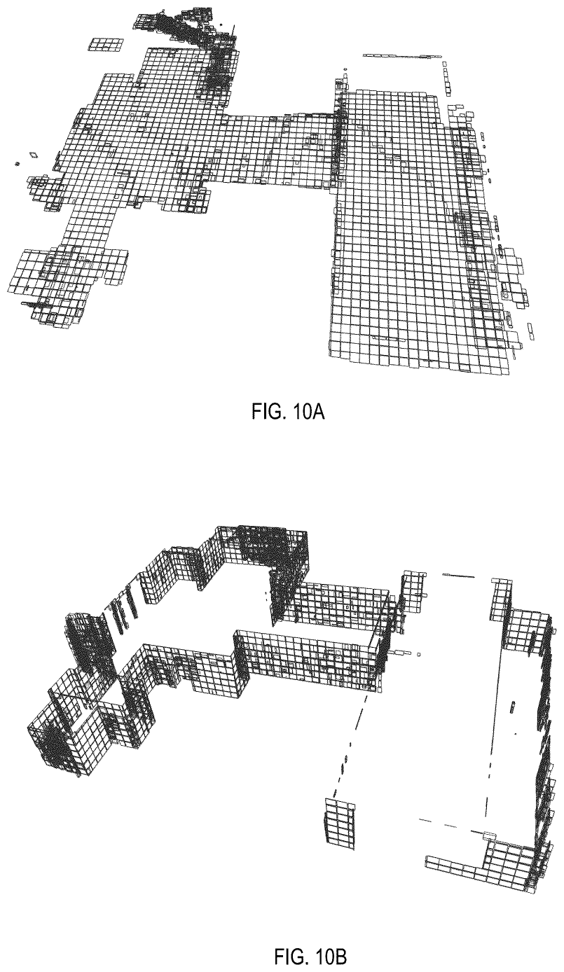

At step 112 plane detection is performed on the floor fragments created in step 110. The result is shown in FIG. 10A.

Steps 111 and 113 are essentially the same as steps 110 and 112, respectively, however the fragmentation and plane detection is performed on wall points. FIG. 10B shows the result of plane detection on wall fragments.

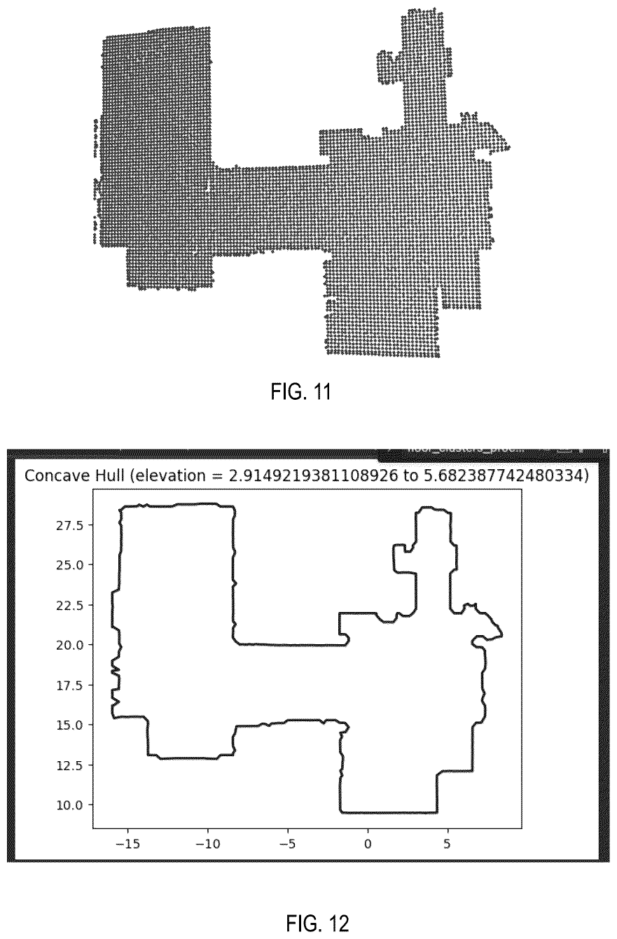

At step 114, detected floor planes are merged to get a basic floor geometry shown in FIG. 11. A concave hull algorithm is then run on the merged floor planes and small, isolated geometries are removed to get a floor shape shown in FIG. 12

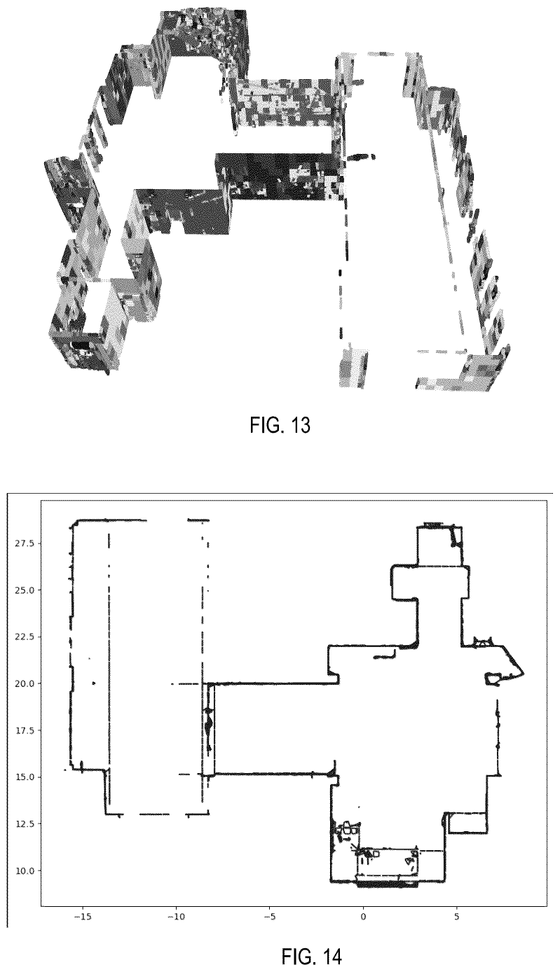

Step 115 is essentially the same as step 114, but performed on detected wall planes to merge the wall planes in each level to get a basic wall geometry shown in FIG. 13.

At 117, a level's merged wall planes are flattened along the Z-axis, by snapping together nearby wall points and merging colinear lines to get a top down, 2D representation of the level's walls. The result is a simplified 2D shape that is converted into geojson line strings as shown in FIG. 14.

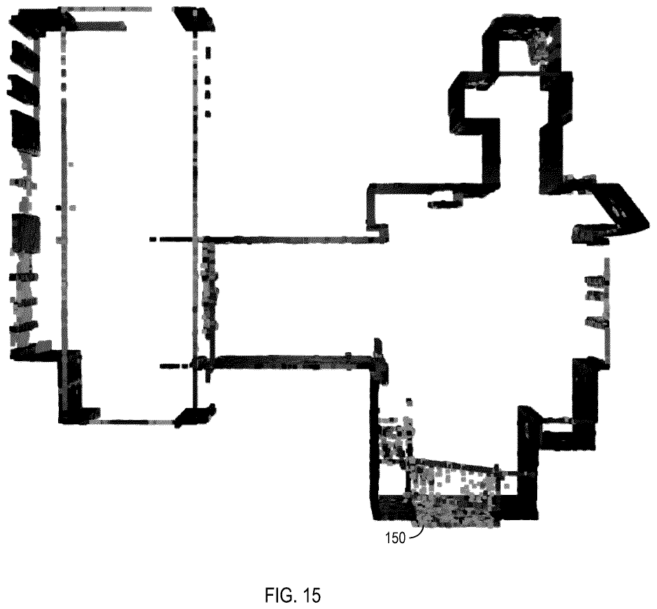

At 119, wall points are grouped, e.g., color coded based on the point density of the flattened 2D representation to find clusters of low-density points, e.g., below a threshold point density, as shown in FIG. 15. Clusters of low-density wall points are shown colored grey (e.g., low-density cluster 150) and high-density wall points are black. Each cluster of low-density points in the 2D representation may correspond to an architectural feature not limited to a door, a window, an area open to below and stairs.

At 121, the clusters of low density wall points are classified to identify corresponding architectural features not limited to doors, windows, areas open to below and stairs. The classification may be performed by a trained neural network configured for classifying clusters of low density wall points as architectural features. The trained neural network may be generative-adversarial neural network (GAN), for example, the GAN disclosed in U.S. Patent Publication No. 20210303763. The GAN may be trained with 2D raster images of floor plans labelled with walls, windows, doors, stairs etc., to learn to better discriminate between these architectural features.

The GAN results may then be used to correct or improve architectural feature detection/classification according to characteristic variations in point cloud density among the architectural features. For example, the GAN may be trained to discriminate between doors having a first characteristic point cloud density (or range of point cloud densities) and windows having a second characteristic point cloud density (or range of point cloud densities) that is different from doors. Similarly, the GAN may be trained to classify other architectural features according to their characteristic point cloud densities.

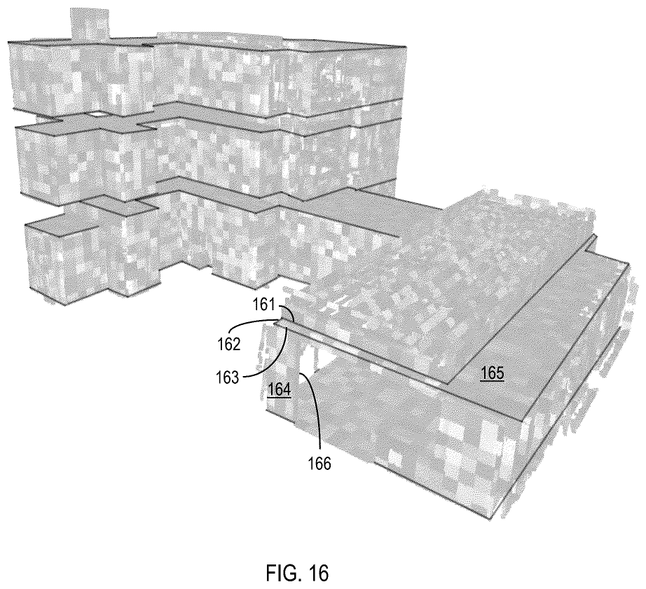

At 116, in some embodiments, line detection is performed to find line intersections of where merged wall planes meet merged floor/ceiling planes. The intersecting lines are used to create straight line boundaries that define 3D walls as shown in FIG. 16. In FIG. 16, detected lines 161, 162, 163 represent an intersection of merged wall planes 164 and merged ceiling planes 165 defining a 3D wall section 166.

It should be noted that following step 108 (detecting levels in the building point cloud data), the subsequent steps 109, 110, 111, 112, 113, 114, 115, 116, 117, 119 and 121 are performed for each level detected at step 108. That is, once levels (or sublevels) are determined at 108, building point cloud data from that level/sublevel is used for the subsequent steps.

At 122, a 2D floor map of a floor or a 3D representation of the building interior is generated, with the architectural features (e.g., doors, windows, stairs) marked therein, e.g., with labels, color coding or icons. To create a 2D floor map, a floor geometry (created at 114) is combined with the architectural features (identified at 121) resulting in a 2D floor map with architectural features marked therein. For a 3D representation, the 3D walls defined at 116 are combined with the architectural features (identified at 121) to create a 3D representation with architectural features marked therein. The various architectural features may be color coded, for example doors are colored blue, windows are colored green, stairs are colored red, etc. Preferably, the 2D floor map or the 3D representation are created in Mappedin Venue Format (MVF), a geoJSON-based file format, allowing for further manipulation of the floor map or 3D representation using suitable software.

According to various embodiments, machine learning (ML) may be further leveraged at various stages in the method 100 to improve the method over time. For example, occlusions may occur during scanning of the building interior and a machine learning model trained on a labelled dataset may be used to fill in gaps in the building point cloud data by line detection (e.g., using Deep Hough Transforms). Similarly, object detection and removal may be performed by a trained ML model (e.g., a trained neural network), to remove/exclude certain objects (such as furniture) from further point cloud processing on the basis of characteristic point cloud density of the objects. In another embodiment, ML may be used for line detection in LIDAR scan images of the building interior to identify lines which can be used to clean, straighten or complete fragmented lines, walls and/or planes in the building point cloud data.

The processing device 16 may include one or more specialized computer processors e.g., graphics processing units for performing various steps described herein. In some embodiments, the processors are configured to operate in parallel to split load and/or perform tasks concurrently. For example, in an embodiment, a first processing unit is configured to implement certain steps in the method 100 for ceiling/floor point data and a second processing unit is configured to implement certain steps in the method 100 for wall point data, in parallel. In another embodiment, a designated processing unit may be configured to process point cloud data for a given level in the building point cloud data. In another embodiment, a first processing unit may be configured to implement a generator network of a GAN and a second processing unit may be configured to implement a discriminator network of the GAN.

While the above description provides examples of one or more apparatus, methods, or systems, it will be appreciated that other apparatus, methods, or systems may be within the scope of the claims as interpreted by one of skill in the art.

1. A computer-implemented method for indoor mapping, comprising:
classifying points in building point cloud data as wall points or ceiling/floor points according to normals of the points in the building point cloud data by a trained machine learning algorithm;
identifying levels in the building point cloud data, by a first machine learning algorithm configured to identify clusters of high ceiling/floor point density, preceding ceiling/floor minimas and following ceiling/floor minimas flanking the clusters of high ceiling/floor point density;
for each level identified:
identifying walls in the building point cloud data, by a second machine learning algorithm configured to identify clusters of high wall point density, preceding wall minimas and following wall minimas flanking the clusters of high wall point density;
fragmenting the ceiling/floor points and the wall points, respectively;
performing plane detection on the ceiling/floor points and the wall points, respectively;
merging detected floor planes to a basic floor geometry;
merging detected wall planes to a basic wall geometry;
flattening wall points in wall planes to a 2D representation;
grouping wall points in the 2D representation based on wall point density;
classifying groups of low wall point density as architectural features by a trained neural network; and
generating a 2D floor map of a level from the basic floor geometry combined with the architectural features.

2. The method of claim 1, further comprising preprocessing the building point cloud data, the preprocessing comprising at least one of: down sampling and outlier removal.

3. The method of claim 1, further comprising: providing the building point cloud data.

4. The method of claim 1, further comprising:
finding line intersections where the wall planes meet the ceiling/floor planes to define 3D walls; and
generating a 3D representation of a building including the architectural features.

5. The method of claim 1, further comprising, for each level identified:
detecting sublevels in the building point cloud data on the basis of point elevation by a machine learning algorithm, the sublevels corresponding to at least a lower wall, a middle wall and an upper wall.

6. The method of claim 1, further comprising:
training a neural network to classify the architectural features on the basis of characteristic point cloud densities of the architectural features.

7. The method of claim 6, wherein training the neural network comprises:
providing 2D raster images of floor plans labelled with various architectural features to the neural network to discriminate between the various architectural features.

8. The method of claim 6, wherein training the neural network comprises:
training the neural network to exclude objects from further processing on the basis of characteristic point cloud densities of the objects.

9. The method of claim 1, wherein the architectural features include at least doors, windows and stairs.

10. A system for indoor mapping comprising:
a processing device configured to:
classify points in building point cloud data as wall points or ceiling/floor points according to normals of the points;
identify levels in the building point cloud data according to clusters of high ceiling/floor point density, preceding ceiling/floor minimas and following ceiling/floor minimas flanking the clusters of high ceiling/floor point density;
for each identified level:
identify walls in the building point cloud data according to clusters of high wall point density, preceding wall minimas and following wall minimas flanking the clusters of high wall point density;
fragment the ceiling/floor points and the wall points, respectively;
perform plane detection on the ceiling/floor points and the wall points, respectively;
merge detected floor planes to a basic floor geometry;
merge detected wall planes to a basic wall geometry;
flatten wall points in wall planes to a 2D representation;
group wall points in the 2D representation based on wall point density;
implement a trained neural network to classify groups of low wall point density as architectural features; and
generate a 2D floor map of a level from the basic floor geometry combined with the architectural features.

11. The system of claim 10, further comprising:
a scanning device configured to scan an interior of a building and generate the building point cloud data.

12. The system of claim 10, wherein the processing device is further configured to:
preprocess the building point cloud data by at least one of: down sampling and outlier removal.

13. The system of claim 10, wherein the processing device is further configured to:
find line intersections where the wall planes meet the ceiling/floor planes to define 3D walls; and
generate a 3D representation of a building including the architectural features.

14. The system of claim 10, wherein the processing device is further configured to, for each level identified:
detect sublevels in the building point cloud data on the basis of point elevation, the sublevels corresponding to at least a lower wall, a middle wall and an upper wall.

15. The system of claim 10, wherein the neural network is trained to classify the architectural features on the basis of characteristic point cloud densities of the architectural features.

16. The system of claim 10, wherein the neural network is trained to exclude objects from further processing on the basis of characteristic point cloud densities of the objects.

17. The system of claim 10, wherein the neural network is trained using 2D raster images of floor plans labelled with various architectural to discriminate between the various architectural features.

18. The system of claim 10, wherein the architectural features include at least doors, windows and stairs.
